(19) United States
(12) Patent Application Publication
(10) Pub. No.: US 2010/0068027 A1
(43) Pub. Date: Mar. 18, 2010

(54) Automated build-by-layer rainbow pallet system

(76) Inventor: Pat R. Mitchell, Stockton, CA (US)

Correspondence Address: Robert Charles Hill, 235 Montgomery Street #821, San Francisco, CA, 94104, US

(21) Appl. No.: 12/584,257

(22) Filed: Sep. 2, 2009

Related U.S. Application Data
(63) Continuation of application No. 11/483,570, filed on Jul. 10, 2006, now abandoned.

(51) Int. Cl. B65G 57/00

(52) U.S. Cl. 414/789.9; 414/791.6; 414/802

(57) ABSTRACT

An automated build-by-layer rainbow pallet system comprises a layer build track and a layer build cart that carries a layer build robot and a number of positions for building rainbow pallets, for storing emptied supply pallets, and for storing empty half-pallets. On the rail-sides are dozens or hundreds of supply pallet conveyors for pallets of products to be picked-from when building the rainbow pallets. These are placed on one or both sides of the layer build track. The layer build robot can position itself in front of the appropriate supply pallet conveyor for picking. Once in position, half or full layers can be picked from the supply pallets and positioned over the target rainbow pallet to be built. The process of picking and building layers as the layer build cart repositions in front of the appropriate supply pallet conveyor is repeated until all of the on-board rainbow pallets have been built. The layer build cart returns to an unloading area where the emptied supply pallets and built rainbow pallets are conveyed off to respective exit conveyors. Several empty pallets are then moved from an empty pallet supply, and placed in the individual rainbow pallet build locations either by robot or conveying. The system is then ready to build more rainbow pallets. The system is controlled by a software program for orchestrating the overall movement and building of pallets.

### BACKGROUND OF THE INVENTION

1. Field of the Invention

The present invention relates to warehouse pallet loading systems, and more particularly to a material layer build robot on a layer build cart that shuttles on rails amongst numerous supply conveyors railside to build heterogeneous “rainbow” pallets for customers one layer at a time from each of several homogeneous supply pallets.

2. Description of Related Art

Conventional practice in food, drug, and consumer health sector has been to assemble pallets of rainbow product or “rainbow pallets” for shipment to their customers. Many times customers need less than whole pallet quantities of single item foods, drugs, consumer health products, and other things shipped to them. Without suitable automation to do the job, manufacturers and distributors have resorted to building rainbow pallets by hand. But loading these pallets manually has been troublesome. One problem is when different size containers are placed on the same layers the towering pallet is unstable. Another problem is the shipping quantities need to be large enough to cover the costs of added handling.

Manufacturers and distributors now try to sell products by the layer delivered in rainbow pallets. Such layering makes automating the process of mixing more feasible. Standard forklifts have been fitted with clamping devices to grip one or more layers of a product and then reposition them on a rainbow pallet. But such method is slow, cumbersome and inaccurate. Damage frequently occurs.

Automation companies started using robots to clamp entire layers from supply pallets and transfer them on to the rainbow pallet. Such offers some advantages over previous ways of doing it, but the robots can not reach a wide enough variety of products from the supply positions. Most prior art systems needed a lot of space, were slow and cumbersome, not very accurate in picking from supply pallets, not very accurate placing layers on rainbow pallets and were high cost.

What is needed is a rainbow pallet building system to pick from hundreds of products very quickly and accurately, and at a reasonable cost.

### SUMMARY OF THE INVENTION

Briefly, an automated build-by-layer rainbow pallet system comprises a layer build track and a large layer build cart. Such cart carries a layer build robot, and has a number of positions for building full or half size rainbow pallets. On the railsides are dozens or hundreds of supply pallet conveyors for pallets of products to be picked-from when building the rainbow pallets. These are placed on one or both sides of the layer build track. The layer build robot can position itself in front of the appropriate supply pallet conveyor for picking. Once in position, half or full layers can be picked from the supply pallets and positioned over the target rainbow pallet to be built and then set on top. The process of picking and building layers as the layer build cart repositions in front of the appropriate supply pallet conveyor is repeated until all of the on-board rainbow pallets have been built. The layer build cart returns to an unloading area where all of the rainbow pallets are conveyed off to a pallet exit conveyor. Several empty pallets are then collected from an empty pallet supply, and placed in the individual rainbow pallet build locations, either by conveying or robot. The system is then ready to build more rainbow pallets. The system is controlled by a software program for orchestrating the overall movement and building of pallets.

An advantage of the present invention is that a system is provided for building mixed or rainbow pallets.

Another advantage of the present invention is that a system is provided that builds rainbow pallets of material at low cost and with high accuracy.

Another advantage of the present invention is to provide rainbow pallets that are built very accurately.

A further advantage of the present invention is that a system is provided that is expandable to a very large number of supply materials within reach of the layer build robot.

The above and still further objects, features, and advantages of the present invention will become apparent upon consideration of the following detailed description of specific embodiments thereof, especially when taken in conjunction with the accompanying drawings.

### BRIEF DESCRIPTION OF THE DRAWINGS

FIG. 1 is a diagram of a warehouse pallet loading system embodiment of the present invention that shows how a robot on a layer build cart can access many railside supply conveyers;

FIG. 2 is a top view diagram of the robot and layer build cart of FIG. 1;

FIG. 3 is a perspective view diagram of supply pallet conveyor like that used in FIG. 1;

FIGS. 4A-4D are perspective diagrams showing the way pallets flow on the supply pallet conveyors of FIGS. 1 and 3; and

FIG. 5 is a plan view of a warehouse embodiment of the present invention with a pallet-layer build robot that rides on a layer build cart between rows of supply conveyors.

### DETAILED DESCRIPTION OF THE INVENTION

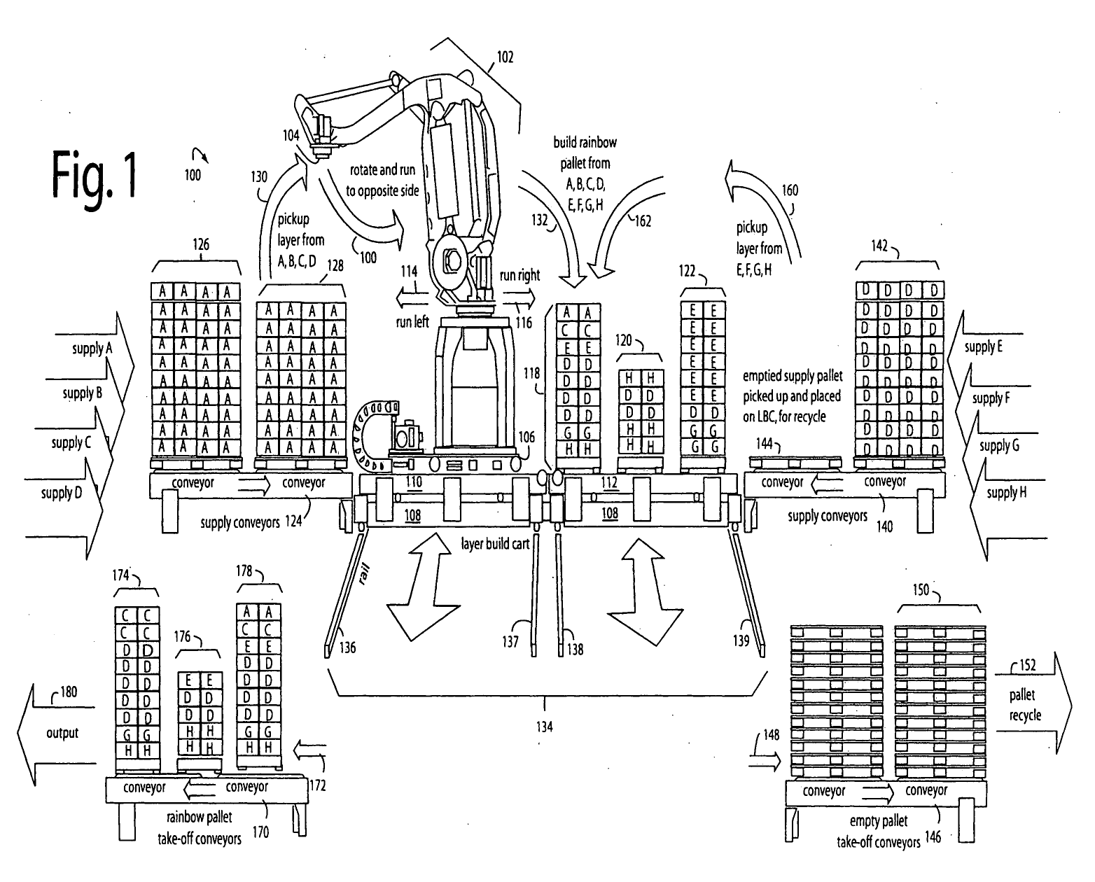

FIG. 1 illustrates a warehouse pallet loading system embodiment of the present invention, referred to herein by the general reference numeral 100. A computer and software program are used (not shown) for orchestrating the overall movement and building of pallets. The system 100 comprises a layer build robot 102 with an appropriate end effector 104 mounted on a lateral shuttle robot car 106. These, in turn, are mounted on longitudinal shuttling layer build cart (LBC) 108. Fore and aft of robot car 106 are pallet building conveyers, e.g., 110 and 112. These allow many pallets to be built up by robot 102 on both sides of its lateral track when moving left 114 and right 116 in FIG. 1. Given enough warehouse space, hundreds of supply conveyors could be accessed trackside by a single LBC 108.

Rainbow” pallets 118, 120, 121, 122 are examples of heterogeneous material pallets that have been built of layers from several different homogeneous material supplies. Each different kind of material layer is labeled A-H in FIG. 1. The supply pallets coming in on respective supply conveyors are all homogenous, e.g., all “A”, all “B”, etc. For example, a supply conveyor for material-A 124 is shown with two A-supply pallets 126 and 128 positioned on a chain conveyor. Robot 102 can do a pickup action 130 of a layer of A-material from A-supply pallet 128, and place it on the rainbow pallet 118 in a depositing action 132. If B-material, C-material, or D-material is needed, layer build cart 108 is moved up and down a layer build track 134 on rails 136-139 to a position close to the appropriate supply conveyor. Material from the right side is picked up by moving LBC 108 on layer build track 134 to an appropriate supply conveyor 140. For example, a material-D is on supply pallet 142.

Short orders from customers will result in smaller stacks, e.g., pallets 120, 121. Rather than run these individually down to the end for off-loading, the shorter stacked pallets 120, 121, can be placed on one another to allow the layer build cart to keep working.

A pallet 144 may be emptied by robot 102 to be picked up and carried on LBC 108 down to an empty pallet take-off conveyor 146. A take-off action 148 by conveyors 110, 122 rolls off stacks of empty pallets 150 for a pallet recycle 152. In some embodiments, the LBC 108 is provided with an empty pallet conveyer. Empty pallets are stacked on this and conveyed off together at the same time the full rainbow pallets are conveyed off on the other side.

After a run right 116, a pickup action 160 by robot 102 at the right side supply conveyors 140 will be followed by a deposit action 162 to build rainbow pallets 118, 120, and 122. Once all the pallets on LBC 108 are complete, the LBC 108 runs down layer build track 134 to a rainbow pallet take-off conveyor 170. A conveying action 172 transfers completed rainbow pallets 174, 176, and 178, from LBC 108 onto the take-off conveyor 170, and thence to an output 180 for wrapping and eventual loading on delivery trucks or return to storage.

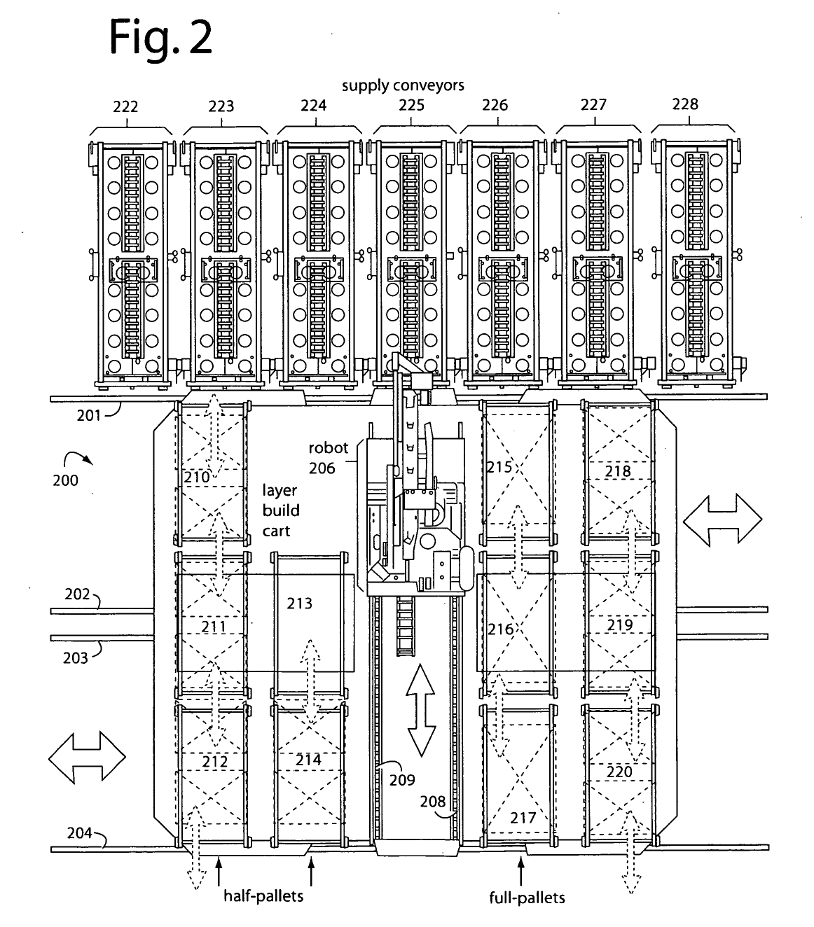

FIG. 2 represents a layer build cart (LBC) 200, like LBC 108 shown in FIG. 1. The layer build cart 200 rides forward and reverse on four rails 201-204. A robot 206, like robot 102 in FIG. 1, is able to laterally traverse on slider rails 208 and 209 across the layer build cart 200. The slider rails enable robot 206 to reach pallets on both sides of the rails 201-204.

Several pallet-building and empty-pallet conveyors 210-220 are located on both sides of robot 206, and each comprises individual conveyor beds that handle two stacks of half-pallets or one stack of full pallets. The half pallets are represented by the X-ed squares with dashed lines, and the full pallets by double-sized X-ed rectangles with dashed lines. Each conveyor bed typically has two outside chain drives and a non-powered roller conveyor. Such allows completed rainbow pallets to be conveyed on-off and across between them, as represented by double-headed arrows. Stacks of empty pallets can also be accumulated on-board and then conveyed off.

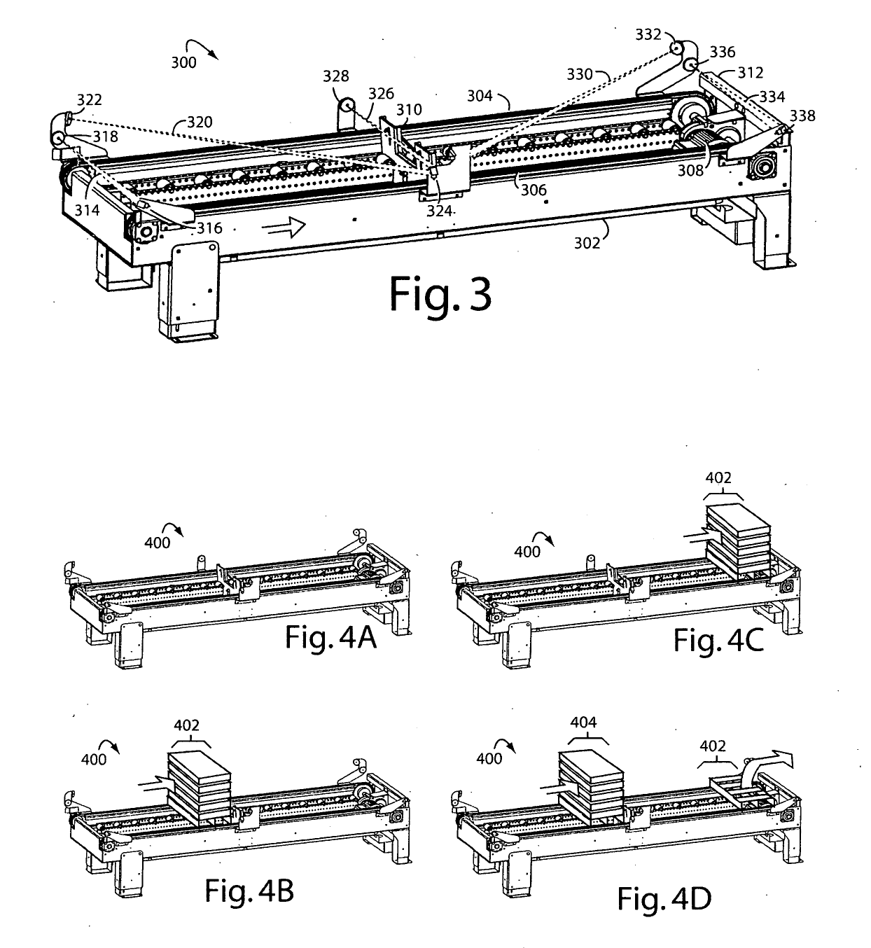

FIG. 3 represents a supply pallet conveyor 300, like: conveyors 124, 140, shown in FIG. 1. The supply pallet conveyor 300 resembles a table with four or more legs and a top. A frame 302 supports outer conveyor chains 304 and 306. These are driven by a motor 308 controlled by a warehouse computer and pallet loading software program. A center stop gate 310 halts full supply pallets entering from the left in a first position. This creates a gap between the two pallets so that pallet layers can be more easily picked up by the end effector 104.

The center stop gate 310 is lowered to allow pallets to continue to the right into the second position where they can be picked by the robot. An end stop 312 positions pallets to be in reach of robot 102, 206 (FIGS. 1-2). A light beam 314 at the entrance is generated and sensed by a pallet detector 316. A reflector 318 is on the opposite side. A diagonal first section beam 320 and reflector help a third pallet detector 324 to sense if any pallets are in the first half of the conveyor in front of gate 310. A gate-stopped pallet detector beam 326 and reflector 328 operate with third pallet detector 324 to sense if any pallets are stopped on the conveyor against gate 310. A second section diagonal beam 330 and reflector 332 help sense if any pallet is in the second section. An end stop beam 334 and reflector 336 are used by an end-stop detector 338 to sense if a pallet is up against end stop 312. Information from detectors 316, 324, and 338, is provided to a control computer to help track the locations of pallets moving through the system 100.

FIGS. 4A-4D represent how supply pallets move along supply pallet conveyor 300 when used in system 100. In FIG. 4A, a supply pallet conveyor 400 begins empty. In FIG. 4B, a fully loaded single product supply pallet 402 is introduced into a first position by a supply carousel or forklift. In FIG. 4C, a full supply pallet 402 has moved to the right into a second position where it can be picked, e.g., by robot 102, 206. In FIG. 4D, the pallet 402 in the second position is now empty, and a second loaded supply pallet 404 has been introduced prior to the first pallet being depleted. Later, robot 102, 206, removes the empty pallets 402 and 404 and stacks them on the LBC 108, 200, to be conveyed off later.

In general, the automated build-by-layer rainbow pallet system embodiments of the present invention comprise a layer build track and a layer build cart for carrying a layer build robot. The cart has a number of positions on-deck for building rainbow pallets. Many supply pallet conveyors for pallets of products are arrayed railside on one or both sides of the layer build track. These can be picked-from by the robot when building a rainbow pallet. Electric motors controlled by computer programs are used by the layer build robot to position itself in front of appropriate supply pallet conveyors for picking. The robot has a special vacuum and/or clamping device for picking layers from the supply pallets. This device is referred to as an end effector. The material is positioned on the target rainbow pallets to be built. The layer build cart is returned to an unloading area so all of the rainbow pallets built may be conveyed off to a pallet exit conveyor. Empty pallets may be collected from an empty pallet supply, and placed in individual rainbow pallet build locations by the robot or conveyed on.

Sensors on the LBC and robot are used to measure the heights of the supply and build pallets so the robot will not miss or crash into the product during picking. A computer and software program orchestrate the overall movement and building of pallets. The program includes a process for picking and building layers as the layer build cart repositions in front of an appropriate supply pallet conveyor. Such is repeatable until all the on-deck rainbow pallets have been built.

The material flow begins by placing a layer build robot on a layer build cart large enough to accommodate several rainbow pallets. Many supply pallet conveyors are arranged along the sides of a rail track provided for the layer build cart. A pallet exit conveyor is provided at a point along the rail track for separate off-loading of the rainbow pallets and empty pallets from the layer build cart.

A pallet storage area is staged next to the rail track so the layer build robot and layer build cart can pick-up or convey on empty pallets to build new rainbow pallets or drop-off empty pallets from the supply pallet conveyors. Empty pallets are loaded onto a layer build cart for building into rainbow pallets. The layer build cart is moved to a position along a rail track to position a supply pallet conveyor within reach of a layer build robot on-board the layer build cart. The layer build robot is used to pick a layer of material from the supply pallet conveyor and place it on one of the on-board rainbow pallets. The layer build cart is moved to a next position along a rail track to put a next supply pallet conveyor within reach of the layer build robot. The layer build robot is used to pick a next layer of material from the next supply pallet conveyor and place it on one of the on-board rainbow pallets. The steps of using and moving are repeated until each of the on-board rainbow pallets is complete according to a control program software. The completed rainbow pallets on-board the layer build cart are transported to pallet exit and empty supply pallet conveyors stationed along the rail track. These transfer the rainbow pallets from the layer build cart 502 to the pallet exit conveyor for wrapping and eventual shipment to customers or storage.

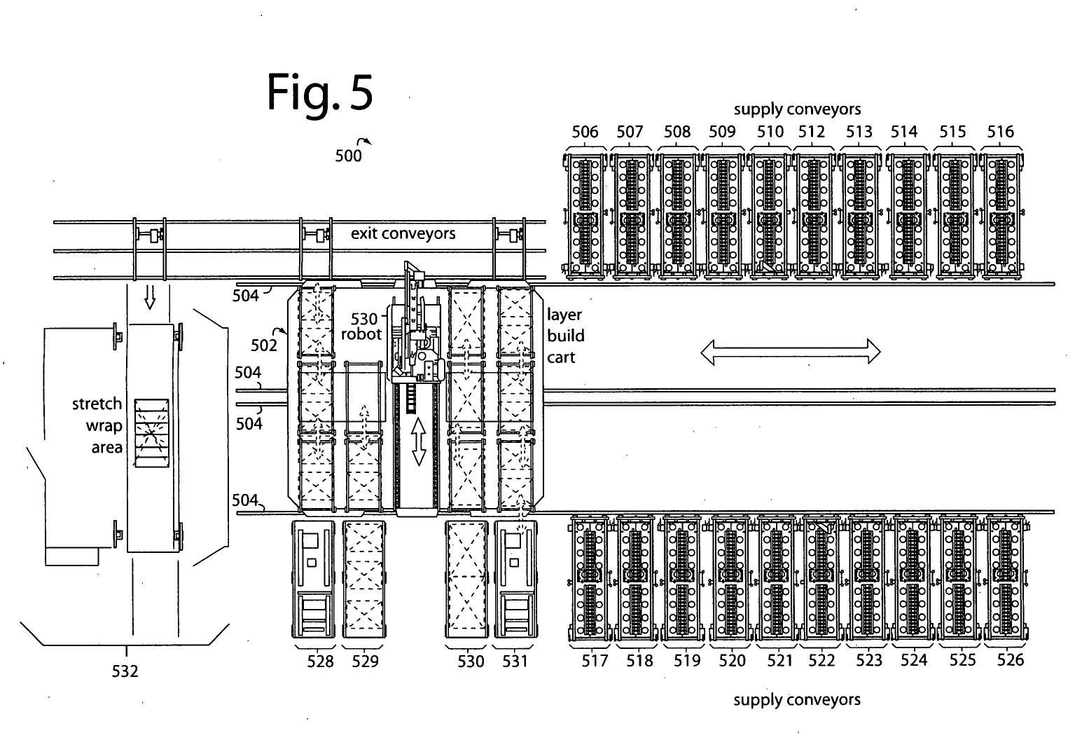

FIG. 5 illustrates a pallet loading system warehouse embodiment of the present invention, referred to herein by the general reference numeral 500. Warehouse 500 comprises a layer build cart 502 that can shuttle along rail tracks 504 between multiple rows of supply conveyors 506-526. These have supplies of single-type material, e.g., A, B, C, E, that are picked to build rainbow pallets, e.g., A-B-C. Empty full and half-size pallets are picked up or dropped off on pallet dispensers 528-531 by layer build cart 502.

When the rainbow pallets are built up, they are off-loaded from cart 502 onto exit conveyors. If shrink wrapping or stretch wrapping is needed for stability, the pallets are wrapped-up in a wrapping station 532. They are then delivered to their ultimate destinations or placed in storage.

Although particular embodiments of the present invention have been described and illustrated, such is not intended to limit the invention. Modifications and changes will no doubt become apparent to those skilled in the art, and it is intended that the invention only be limited by the scope of the appended claims.

1. An automated build-by-layer rainbow-pallet system, comprising:
a layer build track and a layer build cart (LBC) carrying a layer build robot, and having a number of positions on-deck for building rainbow pallets;
a plurality of supply pallet conveyors for pallets of i products to be picked-from when building a rainbow pallet, wherein such are arrayed railside on one or both sides of the layer build track;
means for the layer build robot to position itself in front of appropriate supply pallet conveyors for picking; and
means for picking layers from the supply pallets and positioning them on rainbow pallets to be built;
wherein, a process of picking and building layers as the layer build cart repositions in front of an appropriate supply pallet conveyor is repeatable until a cargo of on-deck rainbow pallets have been built.

2. (canceled)

3. (canceled)

4. (canceled)

5. (canceled)

6. (canceled)

7. (canceled)

8. (canceled)

9. (canceled)

10. (canceled)

11. (canceled)

12. An automated build-by-layer rainbow-pallet system, comprising:
a layer build track;
a layer build cart (LBC) on said track having a number of positions thereon for building rainbow pallets;
a layer build robot on said LBC
a plurality of supply pallet conveyors for pallets of products to be picked-from when building a rainbow pallet, wherein such are arrayed railside on one or both sides of the layer build track;
means for the layer build robot to position itself in front of appropriate supply pallet conveyors for picking; and
means for picking layers from the supply pallets and positioning them on rainbow pallets to be build on said LBC;
wherein, a process of picking and building layers as the layer build cart repositions in front of an appropriate supply pallet conveyor is repeatable until a cargo rainbow pallets have been built on said LBC.

13. The system of claim 12, further comprising:
means for returning the layer build cart to an unloading area so all of the rainbow pallets built may be conveyed off to a pallet exit conveyor, and for collecting empty pallets from an empty pallet supply, and placing them in individual rainbow pallet build locations.

14. The system of claim 12, further comprising:
optical detectors for sensing where pallets are in the system.

15. The system of claim 12, further comprising:
a pallet exit conveyor stationed alongside said layer build track for conveyor-to-conveyor off-loading of completed rainbow pallets from said layer build cart.

16. A rainbow-pallet building system method, comprising:
providing a layer build cart for building multiple rainbow pallets simultaneously;
placing a layer build robot on a layer build cart also large enough to accommodate several rainbow pallets;
arranging many supply pallet conveyors along the sides of a rail track provided for said layer build cart; and
providing a pallet exit conveyor at a point along said rail track for off-loading said rainbow pallets from said layer build cart.

17. The method of claim 16, further comprising:
mounting said layer build robot on slider rails for transverse movement on said layer build cart to increase the reach of said robot.

18. The method of claim 16, further comprising:
stationing a pallet storage area next to said rail track so said layer build robot and layer build cart can pick-up or convey empty pallets to build new rainbow pallets or to drop-off empty pallets from said supply pallet conveyors.

19. The method of claim 16, further comprising:
staking said rainbow pallets on top of one another if any include less than a maximum number of material layers.

20. A rainbow-pallet building system method, comprising:
providing a layer build cart for building multiple rainbow pallets simultaneously;
loading empty pallets onto a layer build cart for building into rainbow pallets;
moving said layer build cart to a position along a rail track to put a supply pallet conveyor within reach of a layer build robot on-board said layer build cart;
using said layer build robot to pick a layer of material from said supply pallet conveyor and putting it on one of said on-board rainbow pallets;
moving said layer build cart to a next position along a rail track to put a next supply pallet conveyor within reach of said layer build robot;
using said layer build robot to pick a next layer of material from said next supply pallet conveyor and putting it on one of said on-board rainbow pallets;
repeating the steps of using and moving until each of said on-board rainbow pallets is complete according to a control program software;
transporting completed rainbow pallets on-board said layer build cart to a pallet exit conveyor stationed along said rail track; and
transferring said rainbow pallets from said layer build cart to said pallet exit conveyor.

21. The method of claim 20, wherein:
transferring is for eventual shipment or storage.

22. The method of claim 20, further comprising:
placing a rainbow pallet on top of another if each includes less than a maximum number of material layers while on said layer build cart.
